(19) United States
(12) Patent Application Publication
(10) Pub. No.: US 2017/0212249 A1
(43) Pub. Date: Jul. 27, 2017

(54) GEL FORMULATIONS FOR DETECTING AND LOCATING RADIOACTIVE SURFACE CONTAMINATION OF SOLID SUBSTRATES, AND DETECTION AND LOCATION METHOD USING SAID GELS

(71) Applicants: COMMISSARIAT A L'ENERGIE ATOMIQUE ET AUX ENERGIES ALTERNATIVES, Paris (FR); AREVA NC, COURBEVOIE (FR)

(72) Inventors: Fadi Azar, AVIGNON (FR); Sylvain Faure, VENASQUE (FR); Marc Messalier, SAINT MICHEL D'EUZET (FR); Laurent Venault, MANDUEL (FR)

(73) Assignees: COMMISSARIAT A L'ENERGIE ATOMIQUE ET AUX ENERGIES ALTERNATIVES, Paris (FR); AREVA NC, COURBEVOIE (FR)

(21) Appl. No.: 15/328,684

(22) PCT Filed: Jul. 28, 2015
(86) PCT No.: PCT/EP15/67305

§ 371 Date: Jan. 24, 2017

(30) Foreign Application Priority Data
Jul. 29, 2014 (FR) 14 57318

(51) Int. Cl. G01T 1/169; G01T 1/20

(52) U.S. Cl. CPC G01T 1/169; G01T 1/20

(57) ABSTRACT

The invention relates to gels for detecting and locating radioactive surface contamination of a solid material substrate, particularly via change in the colour of the gels within the visible range or via attenuation, fading, of the colour of the gels, i.e. decoloration of the gels. The invention also relates to a method for detecting and locating radioactive surface contamination of a solid material substrate that uses said gels.

### TECHNICAL FIELD

The invention is directed toward gels for detecting and locating a radioactive contamination on the surface (“en surface”) (surface radioactive contamination) of a solid substrate.

More specifically, the invention relates to gels to detect and locate an area or spot of radioactive contamination on the surface of a substrate made of a solid material, in particular through a change in colour of the gels in the visible range or through an attenuation of gel colour i.e. a decoloration, fading, of the gels.

By detection and location on the surface (“en surface”) is meant that detecting and locating take place at the surface of the substrate by observation of the gel deposited in the form of a film or layer on this contaminated spot or area, and by radioactive contamination is meant contamination caused by at least one contaminating radioactive species emitting particle radiation e.g. α or β radiation; this radioactive species being present on the surface and possibly underneath said surface in the depth of the substrate.

The present invention further relates to a method for detecting and locating a radioactive contamination on the surface of a substrate made of a solid material, which uses said gels.

The technical field of the invention can therefore generally be defined as the detection and location of radioactive contaminants using gels. Depending on the composition of this film, it may also have decontaminating properties.

### STATE OF THE PRIOR ART

There exist different types of radiation. Depending on their type, a distinction is made between ionising radiation and non-ionising radiation.

Ionising radiation may be either electromagnetic radiation such as γ rays or X rays, or radiation of particles such as α rays, β rays or neutrons.

Herein the focus is more particularly on the evidencing, revealing, detection of surface radioactive contamination, and hence on α and β radiation which deposit their energy locally at a short distance.

In nuclear plants, the staff trained to detect, control and decontaminate premises employing radioactive materials use radiation detection instruments; these are <<conventional physical>> instruments known as contaminometers such as semiconductor detectors, gas chambers, scintillators.

These radiation detectors are relatively cumbersome, costly, require calibration and the use thereof requires trained, skilled personnel. They are difficult to use in the event of a major accident with high dose rates e.g. in and around nuclear reactors, in storage pools and on a daily basis for numerous radiological measurements taken when cleaning or dismantling nuclear areas, workshops and installations in which the dose rate likely to be received within one hour is 0.1Sv.h⁻¹ or higher.

A radiation detector can be defined as a technical device which changes status or situation in the presence of radiation for the detection of which it was specifically designed.

Radiation detection is an essential step for the detection followed by measurement of the activity of radioactive substances.

The detection of nuclear radiation involves interaction between the radiation and a detection material contained in the detector.

Radiation detectors can be classified in two major families depending on the type of interaction between the detection material, detecting medium, and the radiation and the way the detection is carried out.

To the first family of radiation detectors belong detectors in which detection is performed electronically. In other words, these are conventional electronic detectors.

To the second family of radiation detectors belong detectors in which detection is performed visually, these are in general detectors using chemical developers. In these detectors radiations cause chemical reactions leading to a change in colour or behaviour within the detection material, detecting medium.

Among the detectors belonging to this family and commercially available mention may be made of Perspex Harwell Amber® 3042 dosimeters and Far West Technology® (FWT-60) dosimeters.

Perspex Harwell Amber® dosimeters are made of polymethylmethacrylate (PMMA) and consist of optically transparent parts. They are red in colour and are hermetically sealed in sachets. They are in the form of rectangles (30×11 mm) having a thickness of 3±0.55 mm.

They are designed to measure doses in ranges of between 1 and 30 kGy and between 10 and 30 kGy, with UV-Vis spectrophotometry monitoring at 603 and 651 nm respectively.

The accuracy of the absorbed dose measurement is within a few percent in both these ranges.

The principle of detection is the following: at the time of interaction between y ionising radiation and PMMA, free radicals are produced. The dosimeters becomes darker in colour and optical absorbance is modified at the characteristic wavelengths: 603 and 651 nm [Fernandez et al., 2005].

The measurement of absorbance at 603 nm after exposure for a determined time is proportional to the deposited dose. The corresponding dose rate can then be calculated.

Far West Technology® (FWT-60) dosimeters are colourless thin films having a thickness of 47 μm, containing a colouring agent: hexa(hydroxyethyl) aminotriphenylacetonitrile (HHEVC). The colouring agent initially has an absorption band in the UV range at λ=254 nm. When irradiated, the cleavage of the CN-group of the molecule causes a change in colour, from white to purple, as a function of received dose.

Measurement of absorbance by UV-Visible spectrophotometry at 510, 600 and 605 nanometres allows calculation of the absorbed dose.

These dosimeters are designed to measure a dose of between 500 Gy and 200 kGy with an accuracy error of ±6,5%.

However, these dosimeters are not adapted for detection of a alpha or beta surface contamination They can only be used to measure the dose of γ irradiation received by a sample. The most sensitive dosimeters detect a dose in the order of a few Grays.

In addition, radiosensitive chemical gels are known, namely the so-called Fricke gel, the so-called FAX gel (<<Ferrous Agarous Xylenol orange>>) which is a modification of the Fricke gel, and the so-called BANG gel (<<Bis Acrylamide Nitrogen Gel>>) which are solely used in radiotherapy.

The so-called Fricke gel is a gel consisting of a gelled agarose matrix (0.5% by weight) with 0.4 mM iron sulfate (Fe²⁺, SO₄²⁻) [Rousselle et al., 1998].

This gel is concentrated to 25 mM in sulfuric acid (H₂SO₄) to limit oxidation of the Fe²⁺ ions to Fe³⁺. Under γ irradiation, the ferrous ions undergo oxidation and convert to ferric ions (Fe³⁺) [Fenton, 1894]).

To observe this phenomenon with the naked eye, the addition of a metallochromic colouring agent, dye, xylenol orange, to the Fricke gel is essential. The gel thus obtained, derived from a modification of the Fricke gel, is called a FAX gel.

FAX gel changes colour as a function of the content of the metallic iron ion complexed with Xylenol Orange. The compound Fe²⁺-Xylenol orange has yellowish colouring whereas the Fe³⁺-Xylenol orange complex has purple blue colouring.

Fricke gels and FAX gels have been largely used to verify the distribution of a three-dimensional dose in space as delivered by different radiotherapy techniques.

However, these gels contain agarose which is not a rheofluidifying, viscosifying compound meaning that these gels are difficult to spray, do not adhere to a vertical wall and cannot easily be recovered after drying. These gels are therefore not adapted for the detection of surface α and β radioactive contaminations.

BANG gel consists of gelatine (5% by weight) and of an acrylic monomer (3% by weight) distributed within the gel. Under the action of radiations, radicals are created via radiolysis of water and trigger radical polymerisation of the monomers. The gel becomes whitish and visually indicates the presence of radiations. It is noted that on and after a few Grays (e.g. 4.5 Gy), the transparency of the gel decreases. The diminution of transparency is therefore proportional to the received dose.

This Bang gel is sensitive to the surrounding atmosphere, in particular to oxygen in the air which perturbs polymerisation and hence visualisation of the presence of radiations.

Like Fricke gels or FAX gels, BANG gel allows determination of the three-dimensional distribution of a dose on MRI images.

In the light of the foregoing, it therefore appears that there is a need for gels to detect radioactive contamination of a solid surface, which are easy to apply to a surface, preferably using a spray technique, which adhere to all the surfaces on which they are applied irrespective of shape, geometry and orientation of this surface e.g. a vertical surface or a ceiling, and which can be easily removed after drying by using a technique which prevents any dissemination of the contamination.

These gels must also allow the reliable, visually evident detection of this surface contamination, irrespective of the type thereof, whether it is a α contamination or a β contamination.

These gels must have strong sensitivity and ensure detection of contamination even at low doses and activities, and irrespective of the surface material.

Additionally, these gels may advantageously be gels ensuring the decontamination of surfaces the contamination of which has been detected and located.

It is the goal of the present invention to provide detecting, locating and even decontaminating gels which inter alia meet the above-listed needs and requirements.

### DESCRIPTION OF THE INVENTION

This goal and others are achieved according to the invention with an aqueous gel for detecting and locating a radioactive contamination on the surface (“en surface”) of a solid substrate, said contamination being caused by at least one radioactive species emitting a particle radiation, such as a α (alpha) radiation or a β (beta) radiation, found on the surface (“en surface”) of the solid substrate and/or in the surface layer of the substrate, comprising, preferably consisting of:

a water-soluble compound C capable of changing colour in the visible range or of changing emission wavelength outside the visible range, or of exhibiting a decrease in its absorbance e.g. a decoloration, when a film or layer of the gel is placed in contact (contacted) with said surface and said compound C is exposed to the particle radiation emitted by said radioactive species;

a water-soluble, organic, rheofluidifying, viscosifying agent allowing a gel to be produced which, when deposited on the substrate as a film or layer having a maximum thickness of 6 mm, remains transparent in the visible range or in the range of the emission wavelength of compound C outside the visible range, and which, after drying, remains adherent to the substrate; and

a solvent consisting of water (i.e. 100% water).
By gel film or layer is generally meant a film or layer having a thickness of 50 μm to 1 mm for a film, and of 1 mm to 6 mm for a layer.
The gel of the invention comprises a combination of specific components which has never been described or suggested in the prior art.
For example, the gel of the invention comprises a specific solvent consisting solely of water. This is the reason why the gel of the invention is called an aqueous gel. A solely aqueous solvent has advantages in particular in terms of cost, toxicity, fire safety, discharge compared with an organic solvent. Such a solvent, solely, purely, aqueous, also contributes to the transparency of the gel film or layer.

In addition, the gel of the invention comprises an extremely specific viscosifying agent that is defined by six specific characteristics:
This viscosifying agent is organic.
This viscosifying agent is water-soluble which, in conjunction with the use of a solely, purely, aqueous solvent and of a compound C that is also water-soluble, contributes towards obtaining a transparent film or layer of the gel.
This viscosifying agent is rheofluidifying (or pseudo-plastic).
There is a fundamental difference, well-known to the man skilled in the art, between simple viscosifying agents and rheofluidifying, viscosifying agents such as xanthan gum. Some advantages related to the rheofluidifying nature of the viscosifying agent are set forth below.
This viscosifying agent has the property of allowing a gel to be produced which, when deposited on a substrate in a film or layer of maximum thickness 6 mm, remains transparent:
This characteristic is essential insofar as observation of the change in colour in the visible range or in emission wavelength outside the visible range of compound C, would not be observed if the gel film or layer deposited on the substrate were not transparent according to the above definition but opaque.
This viscosifying agent has the property of forming a gel, in association with water and compound C, that can be applied as a film or layer on the substrate. This characteristic is important and advantageous. According to the invention detection and location are specifically obtained by placing in contact (i.e. by applying, depositing or coating) a film or layer of the gel with the surface of the substrate (at least one surface radioactive species being present, found, on the surface (“en surface”) of the solid substrate and/or in the surface layer of the substrate) and not from a distance (remotely) e.g. with a substance lying distant from the surface. This is clearly apparent from the definition of the gel of the invention given above where it is clearly indicated that the gel is a gel <<for detecting and locating a radioactive contamination on the surface (“en surface”) of a solid substrate>> i.e. detection and location are performed on the surface (remotely) (“en surface”) by a change in colour of the applied gel film, and not distant therefrom (remote).
This viscosifying agent has the property of allowing the gel applied to the substrate to form a film after drying which remains adherent to the substrate, this being particularly advantageous to prevent the formation of run-offs, film detachment and to provide compound C with sufficient time to carry out its role as set forth below.
Compound C is also a specific compound since:

Compound C is water-soluble.
Said water-soluble compound C is easier to use than a non-soluble, suspended, compound. It is very homogeneously distributed within the gel, which is an aqueous gel, and within a film or layer of the gel. A gel that has colour homogeneity is thereby obtained.
Since both compound C and the organic, rheofluidifying viscosifying agent are water-soluble, the gel and a film or layer of the gel are transparent, having the advantage of allowing easy observation of colour changes of the gel film or layer.
   In addition, compound C changes colour when exposed to a very specific radiation, namely a α (alpha) radiation or a β (beta) radiation emitted by the radioactive species.
The association of said specific C compound and said specific organic viscosifying agent has never been either described or suggested in the prior art and is at the origin of unexpected and advantageous effects.

The incorporation of said above-described specific compound C in a gel for the detection and location of a radioactive contamination containing a specific viscosifying agent which is an organic viscosifying agent, water-soluble, and rheofluidifying (pseudo-plastic), and allowing the production of a gel of which a film or layer deposited on a substrate remains transparent, has never been described or suggested in the prior art represented in particular by the above-described Fricke gels or FAX gels.

Fricke gels or FAX gels, described above, contain agarose for example which is not a rheofluidifying, viscosifying compound, with all the resulting disadvantages already set forth above.

With the rheofluidifying viscosifying agents of the gels according to the invention, viscosity decreases under the effect of agitation to facilitate spraying of the gel, the time to recover viscosity is short once the gel has been sprayed (e.g. <1s) thereby preventing run-off on a vertical wall or ceiling.

Contrary to Fricke gels or FAX gels, the gels of the invention containing an organic rheofluidifying, viscosifying agent are easy to spray, adhere to a vertical wall and can easily be recovered after drying, for example by peel-off, wipe-off or suction.

The gels of the invention, in particular contrary to Fricke gel or FAX gels, are therefore surprisingly well and specifically adapted for the detection of radioactive contaminations emitting a particle radiation such as a surface α (alpha) radiation or β (beta) radiation.

The gels of the invention allow reliable, easy detection and location, and are easy to use; in other words, they can easily be deployed on site, they are inexpensive since they have recourse to constituents that are widely commercially available and inexpensive.

The gels of the invention may be called gels for the detection and location of a spot of radioactive contamination, which is revealed by the onset of a spot having a colour different to the initial colour of the gel and of a size close to the size of the initial contamination.

The image of the contamination is thus fixed in time.

Importantly, in the gels of the invention whether the gel film is or is not in direct contact with the radioactive species, the change in colour of compound C and hence of the gel film applied to the surface, occurs solely under the effect of the particle radiation emitted by said radioactive species, e.g. by radiolysis, and not under the effect of a chemical reaction between the radioactive species and compound C.

With the gels of the invention there is no need for migration of the radioactive species within the gel film.
Advantageously, the gel also comprises an inorganic, rheofluidifying viscosifying agent.
Advantageously, the gel also comprises a drying retarder and decontamination agent selected from among mineral and organic acids.
Advantageously, the gel comprises 10 to 150 μmol/L, preferably 20 to 80 μmol/L, more preferably 2 to 50 μmol/L of compound C.
This is another advantage of the gel of the invention in that it allows detection substantiated, materialized in particular by a change in colour of compound C at very low concentrations of this compound C.
Advantageously, the gel comprises 10 to 50 g/L of organic, rheofluidifying viscosifying agent.
Advantageously, the organic, film-forming, rheofluidifying, viscosifying, and water-soluble agent is xanthan gum.

According to a first embodiment, compound C is a coloured complex consisting of an organic ligand and a metal ion.

According to this first embodiment, the gels of the invention consist preferably of:

a compound C which is a coloured complex consisting of an organic ligand and a metal ion;

an organic, rheofluidifying viscosifying agent;

an aqueous solvent (water);

optionally a drying retarder and decontamination agent selected from among mineral and organic acids.

The gels according to this first embodiment are therefore preferably organic gels, preferably comprising solely an organic, rheofluidifying, viscosifying, agent and therefore which, preferably, do not comprise an inorganic rheofluidifying viscosifying agent.

The preferred organic, rheofluidifying viscosifying agent is xanthan gum (or xanthan) since it is a rheofluidifying polymer with threshold stress, a fundamental point preventing run-off on a vertical wall or ceiling.

Advantageously, the organic ligand is xylenol orange and the metal ion is a ferrous ion, Iron(II), in solution in sulfuric acid for example at a concentration of 20 mmol/L gel. Therefore, the coloured compound is Xylenol Orange-Iron II.

Optionally, this gel also contains a drying retarder which may also act as decontamination agent, such as an acid e.g. nitric acid, sulfuric acid, perchloric acid, oxalic acid or phosphoric acid e.g. at a concentration of 0.01 to 2 mol/L. Phosphoric acid is preferred. This drying retarder allows easier recovery by wipe-off, increases development time and where appropriate allows decontamination.

Preferably, the gels according to this first embodiment of the invention consist preferably of:

20 to 80 μmol/L of the organic ligand such as xylenol orange;

0.4 mmol/L for example, of the metal ion, such as the ferrous ion, in sulfuric acid, e.g. at a concentration of 20 mmol/L;

10 to 50 g/L of organic, rheofluidifying viscosifying agent such as xanthan gum;

optionally 0.01 to 2 mol/L, preferably 0.2 to 2 mol/L of drying retarder and decontamination agent such as phosphoric acid;

the remainder being water (the balance water).

In these gels, radiolytic oxidation generally occurs of the ligand-metal ion compound under the effect of radiation, and more exactly of the metal ion. Therefore the Xylenol Orange-Iron II compound is oxidised to a Xylenol Orange-Iron III complex.

This surprisingly allows polyvalent detection/location of all alpha and beta emitters deposited on a surface or contained in the surface layer of a substrate, via detection of radiation without conventional chemical reaction as is the case in the method described in document US-A1-2009/0112042 which selectively detects fission products via complexation.

The gels of the invention, according to this first embodiment, allow detection of alpha contamination, e.g. due to plutonium, but also of beta contamination via a change in colour (e.g. from yellow to blue for these so-called <<FXX>>gels: Iron(II)-Xanthan-Xylenol orange) within a few hours, 48 hours at most, for activities of a few 1 000 Bq/cm².

These gels are deposited in a so-called thin, film (or layer). This film generally has a thickness in the order of 50 μm to 6 mm as a function of the anticipated/expected radioactive contamination.

According to a second embodiment of the gels of the invention, compound C is an organic colouring agent (dye).

According to this second embodiment, the gels consist preferably of:

an organic colouring agent (dye);

an organic, rheofluidifying viscosifying agent;

water;

optionally an inorganic, rheofluidifying viscosifying agent;

and optionally a drying retarder and decontamination agent, preferably selected from among mineral and organic acids.

The gels, according to this second embodiment of the invention, are therefore either organic gels when they do not contain an inorganic viscosifying agent, or hybrid, organic-mineral gels when they contain an inorganic viscosifying agent.

As in the first embodiment, the organic, rheofluidifying viscosifying agent is preferably xanthan, since it is a rheofluidifying polymer with a stress threshold preventing the formation of run-off on a vertical wall.

Preferably, the gel according to this second embodiment comprises a mixture of an organic, rheofluidifying viscosifying agent such as xanthan gum, and of an inorganic (or mineral) rheofluidifying co-viscosifying agent such as silica, this inorganic co-viscosifying agent—after drying of the gel—allowing delamination i.e. detachment of the film in a single piece, or fracturing of the gel layer facilitating recovery thereof by brushing or suction.

The organic colouring agent (dye) is soluble in the aqueous solvent; it is therefore a water-soluble colouring agent (dye).

Advantageously, the organic colouring agent may be selected from among Erioglaucine, Xylenol orange, Reactive Black 5, Rhodamine 6 G, Safranine O, Auramine O, Methyl orange, Methyl red, Congo red, Eriochrome Black T, and mixtures thereof.

Among these organic colouring agents, Erioglaucine is preferred on account of its high radiosensitivity.

These gels particularly allow the locating of labile (loose) or fixed surface contamination by decoloration of the organic colouring agent, coloured detector.

In these gels, depending on the type of colouring agent and contamination, a change in colour or attenuation, fading of the colour of the gel generally occurs following a radio-induced reaction, i.e. solely caused by depositing of energy, such as a redox reaction or complexing reaction. However, these gels may also undergo a change in colour or colour attenuation following a radiochemical reaction degrading the organic molecule of colouring agent by radiolysis.

For example, a gel containing Erioglaucine reacts by complexing with labile (loose) contamination of a plutonium (VI) salt.

Preferably, these gels contain a decontamination agent and drying retarder such as an acid e.g. nitric acid, sulfuric acid, perchloric acid, oxalic acid or phosphoric acid, for example at a concentration of 0.01 to 2 mol/L, phosphoric acid being preferred. This drying retarder allows easier recovery via wipe-off, increases development time and allows decontamination.

Further preferably, the gels according to this second embodiment consist of:

20 to 50 μmol/L of the organic colouring agent;

8 to 25 g/L of the organic, rheofluidifying viscosifying agent such as xanthan gum;

optionally 1 to 5 weight % of the inorganic, rheofluidifying, viscosifying agent such as silica;

optionally 0.01 to 2 mol/L, preferably 0.2 to 2 mol/L of the drying retarder and decontamination agent such as an acid e.g. phosphoric acid;

the remainder (balance) being an aqueous solvent, consisting of water.
A third embodiment leads to the inclusion, as compound C, instead of the colour compound Fell-Xylenol orange of the first embodiment or of the organic colouring agents of the second embodiment, of a scintillator which can be radioluminescent in the visible or ultraviolet. The scintillator is excited by the ionising radiation. On de-excitation of the material, the photons emit light in the visible or ultraviolet.
There are two major families of scintillators: inorganic scintillators and organic scintillators.
   Among inorganic scintillators the following may be cited: thallium-doped sodium iodide (Nal(TI)), thallium-doped caesium iodide (CsI(TI)), silver-doped zinc sulfide (ZnS(Ag)), europium-doped lithium (Lil(_{Eu}), barium fluoride (BaF₂) . . . Among organic scintillators mention may be made of: anthracene, stilbene, p-terphenyl . . .

There is no limitation as to the colour of compound C, such as the coloured complex or the water-soluble colouring agent, before application thereof to the surface. This colour is generally the colour that it will impart to the gel.

In general, the colour of the gel is identical to the colour of compound C that it contains. It is possible, however, that the gel has a colour differing from the colour of compound C contained therein, for example when compound C reacts with the active decontaminating agent.

Advantageously, compound C is selected so that it imparts the gels (i.e. the gels in the wet state as defined above, before drying) with a colour differing from the colour of the surface to be treated, onto which the gels are applied.

The gels of the invention meet all the above-mentioned needs and requirements, they do not have the disadvantages, defects, limitations and shortcomings, drawbacks of prior art gels such as FAX gels.

Advantageously and preferably, the organic rheofluidifying viscosifying agent is xanthan gum since first it has cold solubility on and after 20° C., and secondly since it has the best rheological properties in terms of adherence (it is a threshold fluid) on a vertical wall, of viscosity recovery time and of visco-elasticity for application.

The preferred gels of the invention are therefore gels based on xanthan gum in accordance with the two aforementioned embodiments.

When an inorganic, rheofluidifying viscosifier such as silica is added in addition to xanthan, in particular according to the second embodiment, its presence enables weakening and removing, detaching of the hybrid gel film from the wall during drying.

When the gels of the invention contain an inorganic viscosifying agent, the gels are then colloidal solutions which means that the gels of the invention contain solid inorganic particles of viscosifying agent, the elementary, primary particles thereof generally having a size of 2 to 200 nm.

These solid, inorganic, mineral particles act as viscosifier enabling the solution, e.g. the aqueous solution, to gel and thereby adhere to the surfaces of the part to be treated, to be decontaminated, irrespective of their geometry, shape, size and regardless of the location of the contaminants to be removed.

Irrespective of the embodiment, advantageously the inorganic, rheofluidifying viscosifying agent may be selected from among metal oxides such as aluminas, metalloid oxides such as silicas, metal hydroxides, metalloid hydroxides, metal oxyhydroxides, metalloid oxyhydroxides, aluminosilicates, clays such as smectite, and mixtures thereof.

In particular, the inorganic rheofluidifying, viscosifying agent may be selected from among aluminas (Al₂O₃) and silicas (SiO₂).

The inorganic, rheofluidifying viscosifying agent may comprise only one silica or alumina or a mixture thereof, namely a mixture of two or more different silicas (SiO₂/SiO₂ mixture), a mixture of two or more different aluminas (Al₂O₃/Al₂O₃ mixture) or a mixture of one of more silicas with one or more aluminas (SiO₂/Al₂O₃ mixture).

Advantageously, the inorganic rheofluidifying viscosifying agent may be selected from among pyrogenated silicas, precipitated silicas, hydrophilic silicas, hydrophobic silicas, acid silicas, basic silicas such as Tixosil® 73 silica marketed by Rhodia, and mixtures thereof.

Among acid silicas, mention may particularly be made of pyrogenated silicas or fumed silicas <<Cab-O-Sil®>> M5, H5 or EH5, marketed by CABOT, and pyrogenated silicas marketed by EVONIK INDUSTRIES under the trade name AEROSIL®.

Among these pyrogenated silicas, preference is given to AEROSIL® 380 silica having a specific surface area of 380 m²/g which offers maximum viscosifying properties with minimal mineral content.

The silica used may also be a so-called precipitated silica obtained by wet process for example by mixing a solution of sodium silicate and an acid. Preferred precipitated silicas are marketed by EVONIK INDUSTRIES under the trade name SIPERNAT® 22 LS and FK 310, or by RHODIA under the trade name TIXOSIL® 331, this latter being a precipitated silica having a mean specific surface area of between 170 and 200 m²/g.

Advantageously, the inorganic rheofluidifying viscosifying agent may consist of a mixture of precipitated silica and pyrogenated silica.

The alumina may be selected from among calcined aluminas, milled calcined aluminas and mixtures thereof.

For example, mention may be made of the product sold by EVONIK INDUSTRIES under the trade name <<Aeroxide Alumine C>> which is fine, pyrogenated alumina.

Advantageously, according to the invention, the inorganic, mineral, viscosifying agent consists of one or more silica(s) generally representing 1% to 5% by weight.

With such a silica concentration, it is generally possible to ensure drying of the gel at a temperature between 20° C. and 50° C. and at a relative humidity of between 20% and 60% on average, within 30 minutes to 5 hours.

The type of inorganic, mineral viscosifying agent, in particular when it consists of one or more silica(s), impacts the drying of the gels of the invention and the particle size of the residue obtained.

When the gels contain an inorganic viscosifying agent, the dry gels are in the form of particles of controlled size, more specifically of millimetre solid flakes having a size generally ranging from 1 to 10 mm, preferably 2 to 5 mm, in particular by means of the aforementioned compositions of the present invention particularly when the viscosifying agent consists of one or more silicas.

It is specified that the size of the particles generally corresponds to their largest dimension.

In other words, the solid mineral particles of the gels of the invention, for example of silica or alumina type, aside from their viscosifying role, also play a fundamental role during drying of the gels since they ensure either fracturing of the gels leading to a dry waste in the form of flakes, facilitating recovery of the dry gels by suction or brushing, or delamination of the gels allowing recovery of the gels by simple peel-off in one piece.

As its name indicates, the generally acid, drying retarder, limits the phenomenon of gel drying and allows the maintaining of a moist gel film.

In other words, the presence of a drying retarder ensures that the gels only partly dry and no longer dry entirely. The gels still contain molecules of solvent such as water in a proportion of 5 to 40 weight % by e.g. 25% by weight of the weight of the gel at the end of drying. In other words, the gels are still impregnated with water at the end of drying.

The evaluation, observation time is increased and gel recovery is facilitated since it is achieved simply by wipe-off, optionally after rewetting the gel with solvent that it optionally heated.

The drying retarder acts as a decontamination agent in particular if it is an acid.

This decontamination agent allows elimination of a nuclear, radiological, radioactive contaminant, whether organic or mineral, liquid or solid, irrespective of its form; solid or particulate, contained in a surface layer of the material of the part to be treated, in the form of a film or contained in a film e.g. a grease film at (on) the surface of the part, in the form of a layer or contained in a layer e.g. a paint layer at (on) the surface of the part, or simply deposited on the surface of the part.

The decontamination agent and drying retarder may advantageously be selected from among nitric acid, sulfuric acid, perchloric acid, oxalic acid, phosphoric acid and mixtures thereof.

The decontamination agent and drying retarder is generally used at a concentration of 0.01 to 2 mol/L. of gel, preferably 0.2 to 2 mol/L. of gel to guarantee a sufficient drying time of the gel in order to carry out reliable observations during step b) of the method of the invention such as described below, and to achieve decontamination.

For example, the concentration of decontamination agent and drying retarder is selected to ensure drying of the gel at a temperature of between 20° C. and 50° C. and at a relative humidity of between 20% and 60% on average within 30 minutes to 5 hours.

The aqueous solvent of the gel of the invention is consists of water.

The invention further concerns a method for the detection and location of a possible radioactive contamination on the surface (“en surface”) of a solid substrate, said contamination being caused by at least one radioactive species emitting a particle radiation e.g. a α (alpha) radiation or a β (beta) radiation, (said species) being likely (able) to be found, present, on the surface (“en surface”) of the solid substrate and/or in the surface layer of the substrate, wherein the following successive steps are performed:

a) a film or layer of a gel according to the invention such as described above is deposited on said surface;

b) the gel is maintained on the surface for a time, which is the time sufficient to change:
for compound C to change colour in the visible range or to change emission wavelength outside the visible range, or to exhibit a decrease in absorbance, for example a decoloration, due to contacting of the gel film or layer with said surface and to exposure of said compound C to a particle radiation emitted by said radioactive species;
and for the gel to dry and form a dry and solid residue possibly containing said radioactive species;
and during this time, gel colour changes in the visible range or changes of the gel emission wavelength outside the visible range, or decreases in gel absorbance e.g. decolorations of the gel, and the areas(s) of the gel film or layer in which the gel colour changes in the visible range or the changes of the gel emission wavelength outside the visible range occur, or in which decreases in gel absorbance e.g. the decoloration of the gel occur, are observed;

c) optionally the solid and dry residue possibly containing said radioactive species is eliminated, removed;

d) optionally, on the residue remoistened if necessary, changes in colour of the residue in the visible range or changes of the emission wavelength outside the visible range, or decreases in absorbance, are observed.

In the method of the invention, the gels of the invention are deposited directly in contact with the surface to carry out detection and location of the contamination of the substrate.

The method of the invention is a detection method i.e. it gives an indication on the presence or not of a radioactive contamination depending on whether or not occurs, within the whole gel layer deposited, a change in colour of the gels in the visible range or a change in the emission wavelength of the gels outside the visible range, or a decrease in the absorbance of the gels e.g. decoloration of the gels.

The method of the invention is also a method to locate this detected contamination, since the surface area(s) of the gel layer in which changes of the colour of the gel in the visible range, or changes of the gel emission wavelength outside the visible range, or decreases in the gel absorbance e.g. gel decoloration, occur, give an indication on the location of this contamination.

By decrease in absorbance is generally meant that the absorbance of the dry gel (e.g. in flake form) is reduced by 10% to 99% relative to the initial absorbance of the—moist—gel at the time the gel is applied on the surface to be treated.

The observation performed at step b) of the method of the invention that can also be called the gel development step, can be performed visually with the naked eye (in the visible range) or using a spectral camera allowing faster observation of colour changes, and at lower doses, and better distinguishing between areas.

The same applies to the optional observation performed at step d).

Visual detection may result in particular from an attenuation or change in colour of the gel layer upon drying.

The speed at which changes in colour of the gels in the visible range, or changes of the gel emission wavelength outside the visible range, or decreases in gel absorbance e.g. decoloration, attenuation of gel colour, occur, give an indication on the surface activity of the material coated with the gel at step b), or at step d) give an indication on the mass activity of the removed, eliminated, residue.

If the gels used also contain a drying retarder which also acts as decontamination agent, then the method of the invention is also a decontamination method.

The solid substrate may or may not be a porous substrate, without limitation as to the material constituting said substrate.

The method of the invention allows reliable, accurate detection of any radioactive contamination spot emitting alpha and beta radiations, irrespective of the species causing this radiation, and wherever this species is located, and allows location thereof particularly via the onset of a spot in the gel film of different colour and of same size.

This contamination may be a so-called labile (loose) contamination or a fixed contamination i.e. this contamination may be caused by labile (loose), free radioelements which are not attached to the material, immobilised therein, or by fixed, immobilised radioelements.

For example, the contamination may be α or β contamination on the surface of the solid substrate, caused for example by an oxide layer or by particles.

Depending on the type of contamination able to be detected, the formulation of the gel may be adapted accordingly.

More specifically, by means of the method of the invention it possible in particular to detect, locate:

purely surface α or β contamination. This is particularly the case with oxide layers e.g. actinide oxides or with particles.

Detection is performed via a radiochemical reaction i.e. a degradation reaction of the coloured organic molecules by radiolysis.

α particles have very short travel distances inside the material but can nevertheless penetrate inside the gel over a few tens of microns.

Here the contamination is easily located since the area(s) of the gel layer in which gels colour changes in the visible range or changes of the gel emission wavelength outside the visible range, or decreases in gel absorbance e.g. decoloration of the gels, occur, and which are generally in the form of spots in the gel layer, have the size and shape of the initial detected contamination.

β surface contamination. Detection takes place by a radio-induced reaction.

Advantageously, the gel is applied to the surface of the substrate in an amount of 100 g to 2000 g of gel per m² of surface, preferably from 500 to 1500 g of gel per m² of surface, more preferably 600 to 1000 g of gel per m² of surface, which generally corresponds to a gel thickness deposited on the surface of between 50 μm and 6 mm.

In general, the gel film or layer deposited at step a) therefore has an initial thickness of 50 μm to 6 mm.

Advantageously, at step b), drying takes place at a temperature of 1° C. to 50° C., preferably 15° C. to 25° C., and under a relative humidity of 20% to 80%, preferably 20% to 70%.

Advantageously, the gels are left on the surface for a time of 2 to 72 hours, preferably 2 to 48 hours, more preferably 3 to 24 hours.

Advantageously, the dry, solid residues after drying of the film or layer are in particle form, e.g. flakes, having a size of 1 to 10 mm, preferably 2 to 5 mm, or in the form of a dry film.

Advantageously, the dry, solid residues are removed from the solid surface by brushing, suction, peel-off or wipe-off after optional rewetting.

Advantageously, the removed residues can be re-moistened if necessary and the colour changes in the visible range or outside the visible spectrum, or changes in absorbance, can provide an indication on the contamination transferred into these residues.

The method of the invention has all the advantageous properties inherent in the gels used and which have been largely set forth above.

Inter alio, the method of the invention is practical, reliable, safe, easy to implement, in other words it can easily be deployed on site even in complex environments, and at low cost.

To summarise, the method and the gels of the invention inter alio have the following advantageous properties:

application of the gels by spraying,

adherence to walls,

obtaining of maximum detection, location and optionally decontamination efficiency at the end of the drying phase of the gels,

treatment of a very wide range of materials,

no mechanical or physical deterioration of the materials at the end of the treatment,

implementation of the method under varying weather conditions,

reduction in volume of waste,

easy recovery of dry waste,

possible evaluation of contamination transferred into this waste.

Other characteristics and advantages of the invention will become more clearly apparent on reading the following detailed description given solely for illustration and non-limiting, in connection with particular embodiments of the invention given as examples.

### DETAILED DESCRIPTION OF PARTICULAR EMBODIMENTS

The gels of the invention can easily be prepared, generally at ambient temperature.

Preparation of the gels according to the first embodiment of the gels of the invention, gels having a coloured compound, in particular gels containing Iron II, Xanthan and Xylenol orange (hereafter called FXX gels).

In a reactor containing the gel solvent, such as water, is added the organic ligand such as Xylenol orange (Xo), at a concentration for example of between 20 and 80·10^{31 6} mol·L⁻¹.

The mixture is agitated a few minutes to obtain a well homogenised solution.

Sulfuric acid is then added, for example at between 10 and 20·10⁻³ mol·L⁻¹ when the metal ions are Fe²⁺ ions, to limit oxidation of the Fe²⁺ ions to Fe³⁺.

A drying retarder is optionally added e.g. between 1 and 2 M, such as phosphoric acid to limit the drying phenomenon and to maintain a moist gel film.

The solution is left to stand for a few minutes.

During this time, a source of metal ions is added such as a salt, for example a metal nitrate, sulfate, halide, e.g. Iron(II) sulfate, in particular if the ligand is Xylenol orange. For example, it is possible to add between 0.2 and 0.6·10⁻³ mol·L⁻¹ of this metal salt such as Iron(II) sulfate.

The reactor is quickly closed to limit oxidation of the metal ions, e.g. ferrous ions to ferric ions, if the metal ions are sensitive to oxidation by ambient oxygen.

The solution must then be cold stored, for example in a refrigerator, for a sufficient time, e.g. for at least 23 hours, before using the gel, so that the formation of the coloured complex e.g., the Xo-Fe²⁺ complex, reaches thermodynamic equilibrium.

The organic viscosifier such as xanthan gum (Xn) is mixed with the solution thus prepared just before use of the gel.

The necessary amount of organic viscosifier, depending on the desired consistency of the gel, is poured into the solution prepared above, placed in a vessel; for example, between 10 and 50 g of xanthan gum may be poured into 100 mL of the prepared solution.

The content of the vessel is then heated under vigorous stirring using a mechanical impeller, at a rotation speed of 2000 rpm ^{-1,} for example until full solubilisation of the organic viscosifier.

If the organic viscosifier is xanthan gum, it is absolutely necessary that the heating temperature should be controlled: it must not exceed 40° C. to limit acid hydrolysis of the xanthan molecule.

Finally, the prepared gel is centrifuged e.g. at 4400 rpm⁻¹ for 30 seconds to remove bubbles trapped in the gel during agitation.

Preparation of the gels according to the second embodiment of the gels of the invention: gels with organic colouring agent.

The colouring agent may be selected from among commercial water-soluble colouring agents such as Erioglaucine, Xylenol orange, Reactive Black 5, Rhodamine 6 G, Safranine O, Auramine O, Methyl orange, Methyl red, Congo red, Eriochrome Black T.

The colouring agent is added to the aqueous solvent of the gel in an amount such that it allows a solution to be obtained having the desired concentration of colouring agent e.g. between 20 and 60·10⁻⁶ mol·L⁻¹. The mixture of solvent such as water and colouring agent is agitated to homogenise the content of the solution.

The liquid solution of colouring agent thus prepared is gelled through the addition either of an organic viscosifier alone or of a mixture of an organic viscosifier and of an inorganic viscosifier.

These gels in the second embodiment of the gels of the invention may be either organic gels or hybrid organic-mineral gels.

The preferred organic viscosifier is pseudo-plastic and rheofluidifying, such as xanthan gum, and the preferred mixture of organic and inorganic viscosifiers is a mixture of xanthan gum, and of an inorganic pseudo-plastic, rheofluidifying viscosifier such as silica.

A vessel is charged with xanthan gum, at a concentration varying for example between 1 and 5 g/100 mL of colouring agent solution. The optimal concentration of organic viscosifier is 20 to 30 g/L.

The vessel must be slightly heated under agitation using a mechanical impeller for example at a speed of 2000 rpm⁻¹ until full solubilisation of the organic viscosifier.

If the organic viscosifier is xanthan gum, it is absolutely necessary to control the heating temperature: it must not exceed 40° C. to limit acid hydrolysis of the xanthan molecule.

For hybrid gels, the inorganic viscosifier such as silica is added once the xanthan gum is fully solubilised, at a concentration generally of between 10 and 60 g/L of solution.

The gel is left under agitation for a sufficient time, for example 10 minutes, e.g. using a mechanical impeller, at a rotation speed of 2000 rpm⁻¹, for example, to ensure homogenisation of the particles of inorganic viscosifier in the gel.

Evidently, other protocols may be followed to prepare the gels of the invention with the addition of the components of the gel in an order differing from the order mentioned above.

In general, the gels of the invention must have a viscosity lower than 200 mPa·s under a shear of 1000 s⁻¹ to allow spraying onto the contaminated surface from a distance (e.g. at a distance of 1 to 5 m) or in proximity (e.g. at a distance of less than 1 m, preferably 50 to 80 cm). The time to recover viscosity must generally be shorter than one second, and viscosity under low shear higher than 10 Pa·s to prevent run-off on a wall.

The gels of the invention thus prepared are then applied, deposited in the form of a film on a solid surface of a substrate made of a solid material, to detect and locate possible radioactive contamination of the solid substrate, caused by at least one radioactive species likely (able) to be found on the surface (“en surface”) of the solid substrate and/or in the surface layer of the substrate.

In all cases, irrespective of the material, the efficacy of detection, revelation, development by the gel of the invention is very high.

The treated surface may be painted or non-painted.

There is no limitation as to the type of material, or the shape, geometry and size of the treated surface, the gel of the invention and the method using the same allowing the treatment of surfaces of large size and complex geometries, for example having hollows, corner, recesses.

The gel of the invention ensures efficient treatment not only of horizontal surfaces such as floors, but also of vertical surfaces such as walls, or of inclined or overhanging surfaces such as ceilings.

The gel of the invention may be applied to the surface to be treated using any application methods known to the man skilled in the art.

The gel may be sprayed by mere hand spraying or from a distance (using remote operated arms or remote operators) using a pneumatic pump or in the form of a spray.

For application of the gel of the invention by spraying onto the surface to be treated, the gel such as a colloidal solution may for example be conveyed by a low pressure pump, for example a pump applying a pressure of 7 bar or lower i.e. about 7.10⁵ Pa.

The dispersing of the gel jet on the surface may be obtained using flat or round jet nozzles for example.

The distance between the pump and the nozzle may be any distance, for example it may be 1 to 50 m, in particular 1 to 25 m.

The sufficiently short time in which the gels of the invention recover viscosity, in particular when they are organic-mineral gels, enables the sprayed gels to adhere to any surface for example to walls.

The amount of gel deposited on the surface to be treated with regard to organic-mineral gels is generally 100 to 2000 g/m², preferably 500 to 1500 g/m², more preferably 600 to 1000 g/m².

The amount of gel deposited per unit surface areas, and hence the thickness of the deposited gel, has an influence on drying time.

For example, if a layer of organic-mineral gel is sprayed to a thickness of 0.5 mm to 2 mm on the surface to be treated, the efficient contact time between the gel and the materials is then equivalent to the drying time, a period during which the gel will change colour for example, or become discoloured, and optionally the decontamination agent, drying retarder will act on the contamination.

In addition, it has been shown that the amount of deposited organic-mineral gel when within the above-mentioned ranges, and in particular when it is higher than 500 g/m² particularly in the range of 500 to 1500 g/m² this corresponding to a minimum thickness of deposited gel e.g. higher than 500 μm for an amount of deposited gel higher than 500 g/m², allows the obtaining of gel fracturing after drying of the gel in the form of millimetre-sized flakes e.g. of size 1 to 10 mm, preferably 2 to 5 mm allowing suction thereof.

The amount of deposited organic-mineral gel and hence the thickness of the deposited gel, preferably higher than 500 g/m² i.e. 500 μm, is a fundamental parameter impacting the size of the dry residues formed after drying of the gel, and thereby ensuring that dry residues of millimetre size and not powdered residues are formed, these residues being easily removed by a mechanical process and preferably by suction.

The gel is then left on the surface to be treated for all the time needed for drying thereof. During this drying step, that can be considered to be the active phase of the method of the invention, the solvent contained in the gel, namely in general the water contained in the gel, evaporates until a dry and solid residue is obtained.

Drying time is dependent on the composition of the gel within the concentration ranges of the gel constituents given above, but also as already specified on the amount of gel deposited per unit surface area i.e. the thickness of deposited gel.

Drying time is also dependent on weather conditions namely the temperature and relative humidity of the atmosphere weather the solid surface.

The method of the invention can be implemented under extremely wide weather conditions namely at a temperature T of 1° C. to 50° C. and at a relative humidity RH of 20% to 80%.

The drying time of the gel of the invention is therefore generally from 1 hour to 24 hours at a temperature T of 1° C. to 50° C. and at a relative humidity of 20% to 80%.

As already indicated above, the formulation of the gel of the invention, and in particular the type and concentration of the optional drying retarder, decontamination agent, is such that sufficient gel drying time is guaranteed to carry out reliable observations during step b) of the method of the invention such as described below, and optionally to obtain decontamination.

Therefore, the formulation of the gel is generally such that it ensures a drying time that is none other than the time needed by erosion reactions to remove a contaminated surface layer from the material.

The contaminating radioactive species are optionally removed by dissolution of the irradiating deposits or by corrosion of the materials supporting the contamination.

A true transfer of nuclear contamination therefore takes place towards the dry gel, for example in the form of dry gel flakes.

The specific surface area of the mineral filler, load, generally used, which is generally 50 m²/g to 300 m²/g, preferably 100 m²/g, and the absorption capacity of the gel of the invention allow the trapping of labile (surface) and fixed contamination of the material constituting the surface to be treated.

Once the gel has dried, the organic-mineral gel is able to fracture homogeneously to give non-powdery dry solid residues, of millimetre size, e.g. of a size of 1 to 10 mm, preferably 2 to 5 mm generally in solid flake form, or else the gel may form a dry film having a thickness of 100 μm to 500 μm for example.

The dry residues such as flakes obtained after drying have low adhesion to the surface of the decontaminated material.

On this account, the dry residues obtained after drying of the gel can be easily recovered by mere brushing and/or aspiration. However, the dry residues can also be evacuated by a jet of gas e.g. a jet of compressed air.

The dry film can also be recovered by peel-off or simply by wiping-off using an incinerable cloth optionally after rewetting the gel.

Therefore, no rinsing with a liquid is generally necessary and the method of the invention does not generate any secondary effluent.

However, it is also possible if desired, although not preferred, to remove the dry residues by means of a jet of liquid.

On completion of the method of the invention, a solid waste is recovered that can be packaged directly e.g. in flake form that can be packaged as such. As a result, and as already indicated above, there is a significant reduction in the amount of effluent produced and a notable simplification in terms of waste treatment and outlet chain.

In addition, in the nuclear sector, the fact that the flakes do not need to be retreated before packaging of the waste amounts to a considerable advantage.

For example, if 1000 grams of gel are applied per m² of treated surface area, the mass of dry waste produced is less than 200 grams per m².

Therefore, after drying, physical processes that are often hazardous to implement in active zones, such as rubbing and polishing which carry a risk of disseminating radioactive dust in the air are not used, and the gel is easily recovered by suction or peel-off or by mere wiping using an incinerable cloth.

The gel may contain all or part of the initial contamination deposited on the surface.

Subsequent changes in colour of the gel residues after recovery may also be monitored to assess the radiological activity eliminated by the gel.

The invention will now be described with reference to the following examples that are given for illustrative and non-limiting purposes.

### EXAMPLES

In the following examples gels of the invention are used to detect various radioactive contaminations applying the method of the invention.

The gels of the invention used in the examples are either gels with colouring agent or gels containing Iron II, Xanthan and Xylenol orange called FXX gels.

The gels of the invention used in the examples are prepared in the following manner:
Preparation of gels with organic colouring agents used in Examples 3 and 4:

The preparation of the solutions for the gels with colouring agents is performed following the same experimental protocol.

The colouring agent is selected from among commercial water-soluble colouring agents such as Erioglaucine, Xylenol orange, Reactive Black 5, Rhodamine 6 G, Safranine O, Auramine O, Methyl orange, Methyl red, Congo red, Eriochrome Black T.

The colouring agent is added to water in an amount such that it allows the obtaining of a solution having the desired concentration between 20 and 60·10⁻⁶ mol·L⁻¹. The mixture of water and colouring agent is agitated to homogenise the content of the solution.

The liquid solution of colouring agent thus prepared is gelled through the addition of an organic viscosifier.

In the following Examples 3 and 4, the organic viscosifier used that is pseudo-plastic and rheofluidifying is xanthan gum.

Xanthan gum is added to a beaker at the desired concentration which varies between 1 and 5 g/100 mL of colouring agent solution.

The optimal concentration of xanthan varies between 20 and 30 g/L.

The beaker must be slightly heated under agitation using a mechanical agitator at 2000 rpm⁻¹ until full solubilisation of the xanthan gum.

It is strictly necessary to control the heating temperature. It must not exceed 40° C. to limit acid hydrolysis of the xanthan molecule.

For hybrid, organic-mineral gels (Example 4), silica is finally added once the xanthan gum has fully solubilised, at a silica concentration of between 10 and 60 g/L of solution. The gel is left under agitation 10 min using a two-bladed impeller at 2000 rpm⁻¹, to ensure homogenisation of the silica particles in the gel.
Preparation of Iron(II), Xanthan and Xylenol orange gels (so-called <<FXX>> gels), used in Examples 1 and 2:

A flask is charged with Xylenol orange (Xo) at a concentration of between 20 and 80·10⁻⁶ mol·L⁻¹. It is left under agitation for a few minutes to obtain a well-homogenised solution. Between 10 and 20·10⁻³ mol·L⁻¹ of sulfuric acid is added to limit oxidation of the Fe²⁺ ions to Fe³⁺. A drying retarder is then added at a concentration of between 1 and 2 mol·L-1 such as phosphoric acid to limit the phenomenon of drying and to maintain, keep, the gel film moist.

The solution is left to stand for a few minutes. During this time the addition is made of between 0.2 and 0.6×10⁻³ mol·L⁻¹ of iron(II) sulfate and the flask is rapidly closed to limit oxidation of the ferrous ions to ferric ions by ambient oxygen.

The solvent of this gel is water.

The solution may be stored in a refrigerator. The xanthan gum (Xn) is mixed with the solution thus prepared before using the gel.

Between 10 and 50 g of xanthan gum, depending on the desired consistency of the gel, is poured into 100 mL of the prepared solution, contained in a beaker, the content of the beaker is then heated, under vigorous stirring using a mechanical impeller at a rotation speed of 2000 rpm⁻¹, until full solubilisation of the xanthan gum.

It is absolutely necessary to control the heating temperature. It must not exceed 40° C. to limit acid hydrolysis of the xanthan molecule. Finally, the prepared gel is centrifuged at 4400 rpm⁻¹ for 30 seconds to remove the bubbles trapped in the gel upon agitation.

The formulation of the so-called FXX gel used in Examples 1 and 2 is the following:

[Xo]₀=60 μM; [Fe²⁺]₀=0.4 mM; [H₂SO₄]₀=20 mM; [H₃PO₄]₀=1.5 M; [Xn]=20 g·L⁻¹,

where Xo designates Xylenol orange, and Xn designates xanthan.

### Example 1

### Detection of a Spot of Fixed PuO₂ Contamination—Essentially α-Emitting—Using a FXX Gel with a Coloured Complex Having the Above-Specified Formulation

In this example, tests conforming to the method of the invention were performed to detect a fixed spot of real PuO₂ contamination in the order of 6 nmoles·cm⁻² having an initial activity of 3720 Bq and a dose rate of [symbol] =37 Gy·h^{-1,} using a thin layer of gel of the invention having a thickness of about 6 mm.

A circular layer of plutonium oxide of diameter 1 cm and thickness of about 40 μm, forming a contamination spot, was deposited in the centre of a glass dish (nacelle), in other words in the hollow of this glass dish.

A film of the invention was than spread over the layer of plutonium oxide.

As control, a gel film was also spread directly onto the glass of the dish around the contamination spot.

Using JIMP software, histograms were plotted on the statistical distribution of colour values in the gel film.

RGB coding (red-green-blue) is the ideal model to explain the additive synthesis of colours since it represents colour space using the three primary colours, namely: red (wavelength 700 nm), green (wavelength 546.1 nm) and blue (wavelength 425.8 nm).

By coding each of the colour components on an octet, 256 values are obtained for each colour.

RGC encoding was determined for each test to identify the mean colour of the gel.

Photographs were taken of the FXX gel spread over the contamination spot of plutonium oxide in the centre of the glass dish immediately after application of the gel (time t0), and after a contact time of 8 hours (time t1), 23 hours (time t2), and one month (time t3) between the gel and the contamination spot, and each time the corresponding RGB coding was determined.

The RGB code values obtained are given in following Table1:

TABLE 1

| | t0 | t1 | t2 | t3 |
|---|---|---|---|---|
| Red | 202.2 | 102.2 | 71.7 | 129.4 |
| Green | 202 | 96.7 | 84.2 | 138.1 |
| Blue | 42 | 51.9 | 106.2 | 203 |

Table 1 shows that visual detection of the contamination is possible.

The control gel spread over the glass of the dish around the contamination spot and the gel spread over the contamination spot initially have the same yellow colouring.

From a contact time of 8 h with the contamination, small purple-blue spots close to the contact surface started to appear locally within the gel applied on the spot. These developed small spots could be explained by the non-homogeneity of the Pu deposit. These observations first indicate that the gel has reacted over a (gel) thickness of 40 micrometres with the a particles emitted by the contamination spot.

In a second phase, the Xo-Fe²⁺ compound converted to Xo-Fe³⁺ by radiolytic oxidation diffuses in the gel. After 23 h, the purple-blue colouring was observed throughout the entire volume of the gel.

In addition, the yellow colouring of the control gel on the periphery of the spot provided confirmation that the change in colour was indeed due to a radiolysis coming from the contamination.

However, if the gel is kept for several days, it finally oxidises naturally and its yellow colour changes to purple after one month. This can be explained by the fact that the ferrous ions finally oxidise very slowly to ferric ions under the effect of dissolved oxygen and oxygen in the air.

This test was conducted twice to ensure reproducibility of (colour) development. The results were identical.

FXX gel is therefore sensitive to a radiation and allows the detection of contamination by radiolytic oxidation in less than one day.

Therefore, the FXX gel with a coloured complex is radiosensitive and can be used for industrial application in a nuclear plant for the visual detection of a α surface contamination within a few hours.

To increase the sensitivity of this gel, it is possible to complete naked eye colour perception with observation using a spectral camera e.g. the camera supplied by SPECIM®, for more rapid detection of γ contamination at lower doses.

Using a spectral camera, it is possible to scan the surface of the gel spread over the contamination. The results give a 3D spectral image of the gel overlaying another in the visible range. This makes it possible to observe a change in colour non-perceived by the naked eye, by measurement of absorbance.

FXX gel has 1.5 M concentration in phosphoric acid, it dries partially and contains 30% water molecules bonded in the matrix of the gel after drying.

The gel film is always impregnated with water. When spraying warm water onto the gel, the gel will be loaded with water. Recovery of the contaminated gel film is then easily achieved by mere wiping off with a cloth.

### Example 2

### Detection of a CsCl Contamination Spot—Essentially (β-γ Emitting—Using an FXX Gel with a Coloured Complex having the Above-Specified Formulation, and Decontamination with this Gel

In this example tests conforming to the method of the invention were performed, to detect a real fixed contamination spot of ¹³⁷CsCl, having a surface area of about 1 cm² and an initial activity of 20 KBq, using a thin gel layer, film of the invention of a thickness of about 6 mm.

A circular layer of ¹³⁷CsCl of a diameter of 1 cm and of a thickness of about 40 μm, forming a contamination spot was deposited in the centre of a glass dish (nacelle), in other words in the hollow of this glass dish.

A gel film of the invention of a thickness of about 6 mm was spread over the layer of ¹³⁷CsCl.

As a control, a gel film was also spread directly on the glass of the dish around the contamination spot.

Photographs were taken of the FXX gel spread over the ¹³⁷CsCl contamination spot in the centre of the dish immediately after application of the gel (time t0), and after a contact time of 48 hours (time t1) between the gel and the contamination spot, and the corresponding RGB coding was determined each time.

The RGB code values obtained are given in following Table 2:

TABLE 2

| | t0 | t1 |
|---|---|---|
| Red | 194.2 | 70.5 |
| Green | 198.3 | 86.8 |
| Blue | 103.7 | 157 |

Table 2 shows that the change in colour of the FXX gel from yellow to purple is reached after 48 h, indicating especially the presence of caesium β⁻ emissions.

Radiation only made a 1% contribution towards (colour) development, since its attenuation in a gel thickness of 6 mm is infinitely small.

For the purpose of predicting which type of ionising radiation is responsible for colour change, the maximum travel distance of the electrons emitted by disintegration of 137 Cesium (Table 2) was calculated using the following formulas (1) and (2) [Lyoussi, 2010]:

Electron energy lower than 0.8 MeV: R_{B-}(g·cm⁻²)=0.407×E^{1,38}(MeV) (1)

Electron energy between 0.8 and 3.7 MeV: R_{B-}(g·cm⁻²)=0.542×E-0.133 (MeV) (2)

By applying these two formulas to the electrons emitted by disintegration of ¹³⁷Cs, having energies of 0.512 and 1.1174 MeV, courses of 1.6 and 5 mm respectively are obtained. As a result, these electrons are fully attenuated in the gel film and are responsible for the change in colour, since γ radiations are, for their part, only very slightly attenuated.

The gel was then removed by wiping-off as in Example 1.

The final, residual activity of the dish was then measured using a γ counter to determine whether the gel was contaminated, for the purpose of managing the packaging, conditioning thereof.

The final residual activity of the dish was 360 Bq.

The decontamination factor corresponds to the ratio of initial activity to final activity.

The calculated decontamination factor was in the order of 55.5.

These results show firstly that the FXX gel was able to evidence, develop, detect contamination within 48 h, and secondly that it has strong decontaminating properties since it is capable of retaining radioelements within the gel matrix.

These two results therefore indicate the possibility of using this gel on real β-γ contamination in nuclear plants.

The recovery of this gel after detection, decontamination was obtained in the same manner as in Example 1.

It is to be noted here too in this example, that the use of a spectral camera allows visualisation of detection of the contamination in a more sensitive manner than with the human eye, and hence allows detection of said contamination at lower doses.

### Example 3

### Detection of a Spot of Plutonium Nitrate Contamination, Using a Gel with an Organic Colouring Agent According to the Invention

In this example, tests conforming to the method of the invention were performed to detect a contamination spot of plutonium nitrate PuO₂(NO₃)₂ of 7 μmoles·cm⁻², having an initial activity of [symbol] =3860 Gy·h⁻¹, using a thin layer of a gel with a colouring agent according to the invention of a thickness of about 6 mm.

A circular layer of plutonium nitrate of a diameter of 1 cm and of a thickness of about 40 μm forming a contamination spot, was deposited in the centre of a glass dish, in other words in the hollow of this glass dish.

A layer of gel with an organic colouring agent according to the invention was spread over the layer of plutonium nitrate.

As a control, a gel film was also spread directly on the glass of the dish around the contamination spot.

The formulation of the gel said colouring gel used in this example which complexes plutonium to oxidation state (VI), is the following:

[Erioglaucine]₀=50 μM; [HClO₄]=1 M to limit hydrolysis of Pu(VI); [Xn]=20 g·L⁻¹.

The solvent of this gel was water.

Photographs were taken of the gel with the Erioglaucine colouring agent, spread over the “loose” contamination spot of plutonium nitrate in the centre of the dish, immediately after application of the gel (time t0), and after a contact time of 3 hours (time t1) and 23 hours (time t2) between the gel and the contamination spot, and the corresponding RGB code values were determined each time.

It is to be noted, however, that some photos do not exactly reflect the true colour since part of the light was absorbed when passing through the glass of the glove box.

The RGB code values obtained are given in following Table 3:

TABLE 3

| | t0 | t1 | t2 |
|---|---|---|---|
| Red | 104.7 | 153.8 | 113.2 |
| Green | 128.7 | 174.5 | 103.5 |
| Blue | 96.1 | 117.8 | 67 |

Initially (at t0), the contamination spot due to plutonium was observed over the entire surface of the hollow of the dish. The green colouring of the gel was that of Erioglaucine in 1 M perchloric acid medium. The gel colouring changed rapidly, in less than 3 hours, to yellow. The orange-yellow colour is attributed to the complexing reaction between plutonium and Erioglaucine in 1 M perchloric acid medium. After 23 h, the gel dried and the orange-yellow colour was better perceived.

The control gel exhibited a slightly yellow colouring. This is due to diffusion of the complex in the peripheral gel around the spot.

Recovery of this gel after detection, decontamination was obtained in the same manner as in Examples 1 and 2.

This example proves that it is possible to detect plutonium labile (loose) contamination using a gel of the invention which reacts via complexation.

A spectral camera can be used to observe changes in colour at lower doses and more rapidly. The onset of colour change in the gels with colouring agents on Pu contamination can then be observed even if this change in colour is not perceived by the naked eye. This spectral camera, by means of a visual image overlaying an image obtained by 3D spectroscopic measurement of the gel, provides confirmation of the presence of ionising radiations interacting with the gel and responsible for the colour change.

### Example 4

### Detection of Alpha Radiation Using a Gel with an Organic Colouring Agent According to the Invention

In this example, tests were performed conforming to the method of the invention to detect γ radiation using a thin layer of gel of 1 mm thickness.

The formulation of the so-called gel with a colouring agent used in this example was the following:

[Colouring agent]₀=30 μM; [Xn]=20 g·L⁻¹; [SiO₂]=20 g·L⁻¹.

The solvent of this gel was water.

The tested colouring agents were classified by the inventors according to their decreasing radiosensitivity order, obtained after experiments performed on deposited alpha contaminations of Pu oxide having controlled surface radiological activity, conducted on liquid samples having the same concentration: Erioglaucine, Xylenol orange, Reactive black 5, Rhodamine 6 G, Safranine O, Auramine O, Methyl orange, Methyl red, Congo red, Eriochrome Black T.

The deposited thin layer of gel dried naturally for 10 h at 25° C., under relative humidity RH of 40% at a drying air velocity Vair of 0.035 m·s⁻¹.

The presence of silica in these gels acted as creator of stress within the gel film upon drying. This resulted in weakening of the gel film upon drying. The film could easily be removed simply by peeling off.

### REFERENCES

1. [Fernandez et al., 2005]: A. Fernandez Fernandez, B. Brichard, H. Ooms, R. Van Nieuwenhove, & F. Berghmans, “Gamma Dosimetry Using Red 4034 Harwell Dosimeters in Mixed Fission Neutrons and Gamma Environments”, IEEE Transcations on Nuclear Science, Vol. 52, No. 2, Avril 2005.
2. [Rousselle et al., 1998]: Rousselle I., B. Castelain, B. Coche-Dequeant, T. Sarrazin, and J. Rousseau, “Contrôle de qualité dosimétrique en radiothérapie stéréotaxique à l'aide de gels radiosensibles”, Cancer/Radiothérapie, 2(2): p. 139-145, 1998.
3. [Fenton, 1894]: Fenton H. J. H. LXXIII, “Oxidation of tartaric acid in presence of iron”, Journal of the Chemical Society, Transactions. 65(0): p. 899-910, 1894.
4. [Lyoussi, 2010]: Lyoussi A., “Détection de rayonnements et instrumentation nucléaire”. EDP SCIENCES New York, Chap. 2, pp. 3-46, 2010.

1. An aqueous gel for detecting and locating a radioactive contamination on the surface of a solid substrate, said contamination being caused by at least one radioactive species emitting a particle radiation present on the surface of the solid substrate and/or in the surface layer of the substrate, comprising:
a water-soluble compound C, capable of changing colour in the visible range or of changing emission wavelength outside the visible range, or of exhibiting a decrease in absorbance when a film or layer of the gel is contacted with said surface and said compound C is exposed to a particle radiation emitted by said radioactive species;
a water-soluble, organic, rheofluidifying, viscosifying agent allowing a gel to be produced which, when deposited on the substrate as a film or layer having a maximum thickness of 6 mm, remains transparent in the visible range or in the range of the emission wavelength of compound C outside the visible range, and which after drying remains adherent to the substrate; and
a solvent consisting of water.

2. The gel according to claim 1, comprising 10 to 50 g/L of organic, rheofluidifying viscosifying agent.

3. The gel according to claim 1, wherein the organic rheofluidifying, viscosifying agent is xanthan gum.

4. The gel according to claim 1, comprising 10 to 150 μmol/L, of compound C.

5. The gel according to claim 1, further comprising an inorganic, rheofluidifying viscosifying agent.

6. The gel according to claim 1, further comprising a drying retarder and decontamination agent selected from the group consisting of mineral and organic acids.

7. The gel according to claim 6, wherein the decontamination agent and drying retarder is selected from the group consisting of nitric acid, sulfuric acid, perchloric acid, oxalic acid, phosphoric acid and mixtures thereof.

8. The gel according to claim 5, wherein the inorganic, rheofluidifying viscosifying agent is selected from the group consisting of metal oxides, metalloid oxides, metal hydroxides, metalloid hydroxides, metal oxyhydroxides, metalloid oxyhydroxides, aluminosilicates, clays and mixtures thereof.

9. The gel according to claim 8, wherein the inorganic, rheofluidifying viscosifying agent is selected from the group consisting of pyrogenated silicas, precipitated silicas, hydrophilic silicas, hydrophobic silicas, acid silicas, basic silicas and mixtures thereof.

10. The gel according to claim 9, wherein the inorganic, rheofluidifying viscosifying agent consists of a mixture of precipitated silica and pyrogenated silica.

11. The gel according to claim 1, wherein compound C is a coloured complex consisting of an organic ligand and of a metal ion.

12. The gel according to claim 11, wherein the organic ligand is xylenol orange and the metal ion is ferrous ion, Iron(II), in solution in sulfuric acid at a concentration of 20 mmol/L of gel.

13. The gel according to claim 11, wherein the gel does not comprise an inorganic, rheofluidifying viscosifying agent.

14. The gel according to claim 13, consisting of:
20 to 80 μmol/L of organic ligand;
0.4 mmol/L of the metal ion in sulfuric acid, at a concentration of 20 mmol/L;
10 to 50 g/L of the organic, rheofluidifying viscosifying agent;
optionally 0.01 to 2 mol/L of a drying retarder and decontamination agent;
the remainder being water.

15. The gel according to claim 1, wherein compound C is an organic colouring agent.

16. The gel according to claim 15, wherein the organic colouring agent is selected from the group consisting of among Erioglaucine, Xylenol orange, Reactive Black 5, Rhodamine 6 G, Safranine O, Auramine O, Methyl orange, Methyl red, Congo red, Eriochrome Black T, and mixtures thereof.

17. The gel according to claim 15 consisting of:
an organic colouring agent;
an organic, rheofluidifying viscosifying agent;
optionally an inorganic, rheofluidifying viscosifying agent;
water;
and optionally a drying retarder and decontamination agent selected from the group consisting of mineral and organic acids.

18. The gel according to claim 17, consisting of:
20 to 50 μmon of the organic colouring agent;
8 to 25 g/L of the organic, rheofluidifying viscosifying agent;
optionally 1 to 5% by weight of the inorganic, rheofluidifying viscosifying agent;
optionally 0.01 to 2 mol/L, of drying retarder and decontamination agent;
the remainder being water.

19. The gel according to claim 1, wherein compound C is a scintillator.

20. A method to detect and locate a possible radioactive contamination on the surface of a solid substrate, said contamination being caused by at least one radioactive species emitting a particle radiation which is able to be found on the surface of the solid substrate and/or in the surface layer of the substrate, wherein the following successive steps are performed:
a) a film or a layer of a gel according to claim 1 is deposited on said surface;
b) the gel is maintained on the surface for a time, which is the time sufficient:
for compound C to change colour in the visible range or to change emission wavelength outside the visible range, or to exhibit a decrease in its absorbance due to contacting of the gel film or layer with said surface and to exposure of said compound C to a particle radiation emitted by said radioactive species;
and for the gel to dry and form a dry and solid residue possibly containing said radioactive species;
and during this time, the gel colour changes in the visible range or changes of the gel emission wavelength outside the visible range, or decreases in gel absorbance and of the areas(s) of the gel film or layer in which the gel colour changes in the visible range or the changes of the gel emission wavelength outside the visible range occur, or in which decreases in gel absorbance occur, are observed;
c) optionally, the dry and solid residue possibly containing said radioactive species is removed;
d) optionally, on the residue moistened if necessary, changes in colour of the residue in the visible range or changes of the emission wavelength outside the visible range, or decreases in absorbance, are observed.

21. The method according to claim 20, wherein during step b) the gel colour changes in the visible range or the changes of the gel emission wavelength outside the visible range, or the decreases in gel absorbance and the area(s) of the gel film or layer in which the gel colour changes in the visible range or the changes of the gel emission wavelength outside the visible range, or decreases in gel absorbance occur, are observed with the naked eye or using a spectral camera.

22. The method according to claim 20, wherein contamination is a α or a β contamination on the surface of the solid substrate, caused by an oxide layer or by particles.

23. The method according to claim 20, wherein the gel is applied to the surface of the substrate in an amount of 100 g to 2000 g of gel per m² of surface area.

24. The method according to claim 20, wherein the gel film or layer deposited during step a) has a thickness of 50 μm to 6 mm.

25. The method according to claim 20, wherein during step b) drying is conducted at a temperature of 1° C. to 50° C., and under a relative humidity of 20% to 80%.

26. The method according to claim 20, wherein the gel is maintained on the surface for a time of 2 to 72 hours.

27. The method according to claim 20, wherein the dry solid residue is in the form of particles having a size of 1 to 10 mm, or in the form of a dry film.

28. The method according to claim 20, wherein the dry solid residue is removed from the solid surface by brushing, suction, peel-off or wipe-off after optional rewetting.
